(19) United States
(12) Patent Application Publication
(10) Pub. No.: US 2005/0272023 A1
(43) Pub. Date: Dec. 8, 2005

(54) Method and apparatus for providing product-information, and computer product

(75) Inventors: Kosei Takano, Tokyo (JP); Daiji Yamano, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/169,806

(22) Filed: Jun. 30, 2005

Related U.S. Application Data
(63) Continuation of application No. PCT/JP03/06012, filed on May 14, 2003.

(51) Int. Cl. G06F 17/60

(52) U.S. Cl. 434/350; 434/362

(57) ABSTRACT

A training server, which is interconnected to a terminal device of an insurance company, provides various types of information pertaining to financial commodities offered by the insurance company to a terminal device of a consumer via a network. The training server conducts, through the terminal device of the consumer, a training that facilitates understanding of the explanation of a product and terms and conditions of a contract that a salesperson of the insurance company gives to a contract applicant.

### BACKGROUND OF THE INVENTION

1. Field of the Invention

The present invention relates to a technology for providing, via a network, information that should be provided at the sale of a product accompanying consumer accountability.

2. Description of the Related Art

In recent years, there have been products that demand consumer accountability at the time of selling. For instance, before signing contracts for financial products such as life insurance etc., an operating personnel or a distributor (hereinafter, “Salesperson”) of a life insurance company explains the product and terms and conditions of the contract (including bookmarks of the contract.) to a contract applicant, and executes the sale or the contract after obtaining a consent of the contract applicant. The structure of the life insurance is complicated and the salespersons who understands especially the terms and conditions of the contract are almost rare. Therefore, in the life insurance companies, the salespersons are being trained periodically during the launch of a new product or modification of the terms and conditions of the contract.

In a conventional technology disclosed in Japanese Patent Laid-Open Publication No. 2000-148844 pertaining to sales contract of the financial products, insurance details corresponding to customer information are provided by the customer. An accounts executive such as the distributor carries a portable terminal device or a portable printer to a customer, and using an insurance information processing program executed with the aid of the portable terminal device, gets the insurance details of the customer. Upon receiving an approval from the customer on the disclosed insurance details, an insurance slip, with all the required entries duly completed, is printed with the aid of the printer.

However, although the rule states that the details of the product and the terms and conditions of the contract have to be given, the salespersons themselves rarely understand the terms and conditions fully. Furthermore, it is observed that the applicants fail to understand the concept saying “I leave it up to you, if you give me the guarantee”, and even the salespersons say “Please go through the terms and conditions carefully and get back to us in case of doubts.” instead of giving a detailed explanation of the product and the terms and conditions of the contract.

Therefore, if the consent of a contract or sale is obtained when the consumer has inadequate understanding of the product and the terms and conditions of the contract due to insufficient give and take of the information, there is a high possibility of occurrence of trouble between a seller (the life insurance company) and the consumer (a policyholder). For example, at the payment of an insurance amount, trouble arises due to the difference between the insurance details (a face value) and the insurance amount. In this case, even if the life insurance company retorts saying “The terms and conditions state that the payment amount fluctuates according to the prevailing conditions of insurance amount payment, and a general explanation was given by the salesperson at the time of signing the contract”, there are some policyholders who say “We were not informed” or “We did not know at all”. This may develop into a lawsuit and the life insurance company may be forced to bear a loss in order to avoid further trouble.

Therefore, when selling the products that demand consumer accountability, it is vital to have a system that will help the consumers understand the details of the product and the terms and conditions of the contract. Preferably, a framework that will facilitate the consumer to understand the contents explained as a part of accountability, and avoid the occurrence of trouble between the consumer and the seller.

### SUMMARY OF THE INVENTION

An apparatus according to an aspect of the present invention, which is an apparatus for providing information on a product, which accompanies an accountability to a consumer at a time of selling the product, to a client device of the consumer via a network, includes: a training conducting unit that conducts a training pertaining to the information for the consumer through the client device; and a training-history storing unit that stores a training history indicating a progress of the training.

A method according to another aspect of the present invention, which is a method for providing information on a product, which accompanies an accountability to a consumer at a time of selling the product, to a client device of the consumer via a network, includes: conducting a training pertaining to the information for the consumer through the client device; and storing a training history indicating a progress of the training.

A computer-readable recording medium according to still another aspect of the present invention stores a computer program that causes a computer to execute the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an overview of a training system according to an embodiment of the present invention;

FIG. 2 is a block diagram of a training server;

FIG. 3 is a diagram of information stored in a participant DB;

FIG. 4 is a diagram of information stored in a training contents DB;

FIGS. 5A and 5B are diagrams of information stored in an insurance DB;

FIG. 6 is a diagram of information stored in an attendance history DB;

FIG. 7 is a diagram of information stored in an attendance condition DB;

FIG. 8 is a flowchart of a training contents selection process;

FIG. 9 is a flowchart of a training process;

FIG. 10 is a flowchart of an insurance company correspondence process;

FIGS. 11 to 14 are diagrams of screens displayed on a consumer terminal device;

FIG. 15 is a drawing illustrating a computer system according to another embodiment of the present invention; and

FIG. 16 is a block diagram of a main unit of the computer system shown in FIG. 15.

### DETAILED DESCRIPTION OF THE PREFERRED EMBODIMENTS

Exemplary embodiments of the present invention are explained in detail with reference to the accompanying drawings. A training system that realizes the present invention is explained as the embodiment. The main terms used in the embodiment are explained first. Outline and features of the training system are explained next. Configuration and procedure of a training server that is a core of the training system is explained next. Further, usage of the training system from a consumer's viewpoint is explained, and finally, various modifications are explained as another embodiment.

The main terms used in the present embodiment are explained briefly. The term “Product” used in the present embodiment indicates the products having consumer accountability at the time of selling, for instance, financial products such as a life insurance offered by life insurance companies. Salespersons explain the product and terms and conditions of a contract (including bookmarks of the contract.) pertaining to the life insurance to a contract applicant, and execute a sales contract after obtaining the consent of the contract applicant.

The term “Training” used in the present embodiment indicates the training (e-learning) pertaining to the contents explained as part of accountability of the products and which is conducted using the Internet. For instance, training sessions such as “surplus and dividends” and “structure of a whole life insurance” pertaining to the life insurance offered by the life insurance companies. The training sessions facilitate the contract applicant to understand the explanation of the products and the terms and conditions of the contract that the salesperson of the life insurance company gives to the contract applicant.

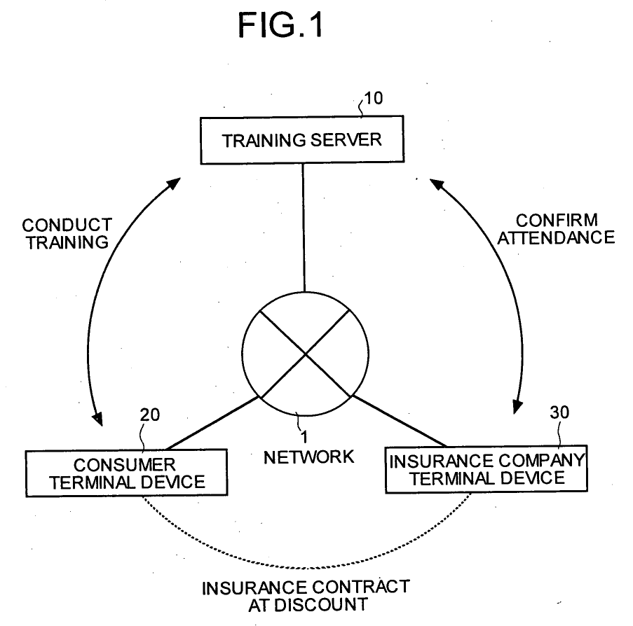

The outline and the features of the training system according to the embodiment of the present invention are explained next with reference to FIG. 1. FIG. 1 is an overview of the training system according to the embodiment of the present invention. The training system according to the present embodiment includes a training server 10 possessed by a training institution, a consumer terminal device 20 possessed by the consumer, and an insurance company terminal device 30 possessed by the insurance company. The training server 10, the consumer terminal device 20, and the insurance company terminal device 30 are interconnected such that communication is possible between the training server 10, the consumer terminal device 20, and the insurance company terminal device 30 via a network 1 such as the Internet.

Schematically, the training server 10 and the insurance company terminal device 30 are connected, and the training system provides to the consumer terminal device 20 of the consumer via the network 1, various information pertaining to the financial products (the products having consumer accountability when selling) offered by the insurance company. The consumer terminal device 20, for instance, may be a personal computer or a workstation, a home video game machine, an Internet television (TV), a personal digital assistant (PDA) or a mobile communication terminal such as a mobile phone or a personal handy-phone system (PHS).

The main feature of the training system is the processing done by the training server 10. The training server 10 prevents occurrence of trouble between the consumer and a seller by conducting the training (the training pertaining to the contents explained as a part of accountability of the products), which facilitates the contract applicant to understand of the explanation of the product and the terms and conditions of the contract that the salesperson of the life insurance company gives to the contract applicant via the consumer terminal device 20 of the consumer.

In other words, for the financial products that demand consumer accountability when selling, by facilitating easy understanding of the contents explained as a part of accountability, the consent of the contract or the sale can be obtained on the assumption (in other words, a guarantee of accountability for having received the training) that the consumer fully understands the contents and the terms and conditions of the product. Consequently, the policyholder is convinced about the insurance payment without any trouble, thereby enhancing the relationship between the insurance company and a policyholder (the consumer).

An additional feature related to the main feature of the training system according to the present embodiment is explained next. With the aid of the training server 10, a suitable training is given based on the type of the insurance product that the consumer wishes to have purchasing contract of, thereby facilitating understanding of the consumer according to the type of the insurance product.

A basic training that helps the consumer to understand which insurance product is suitable for him/her is followed by a more specific training that specializes in the types of the insurance products that the consumer wishes to have the purchasing contract of, is given with the aid of the training server 10, thereby improving the understanding of the consumer step-by-step. Further, based on attributes such as consumer's age, occupation, family structure, etc., a suitable training is given, thereby enhancing the understanding of the consumer.

By using the training server 10, training subjects repeated in the past attendance history are excluded, a training subject prescribed according to the attendance history is included in the training, and a suitable training according to the attendance history is given. Thus, continuous improvement of the understanding of the consumer is ensured. Further, a test stimulates willingness of the consumer who receives the training, and objectively reveals the degree of understanding of the consumer, thereby enhancing and consolidating the understanding of the consumer effectively.

The progress (including a test result) of the training conducted for the consumers is stored as a history in the training server 10. The insurance company terminal device 30 assesses the attendance of the contract applicant by referring to a training history stored in the training server 10, and sells the financial product to the consumer for whom the training is conducted. In other words, the consumer fully understands the contents of accountability through the training, thereby ensuring a smooth execution of the sales contract of the financial product.

Further, the insurance company terminal device 30 assesses the attendance of the contract applicants, and executes an insurance sales contract by offering a discount on an insurance premium to the contract applicants who clear the test. In other words, by offering the discount when merchandising in the form of incentives, the willingness of the consumers for the training is stimulated, thereby further enhancing the understanding of the consumers.

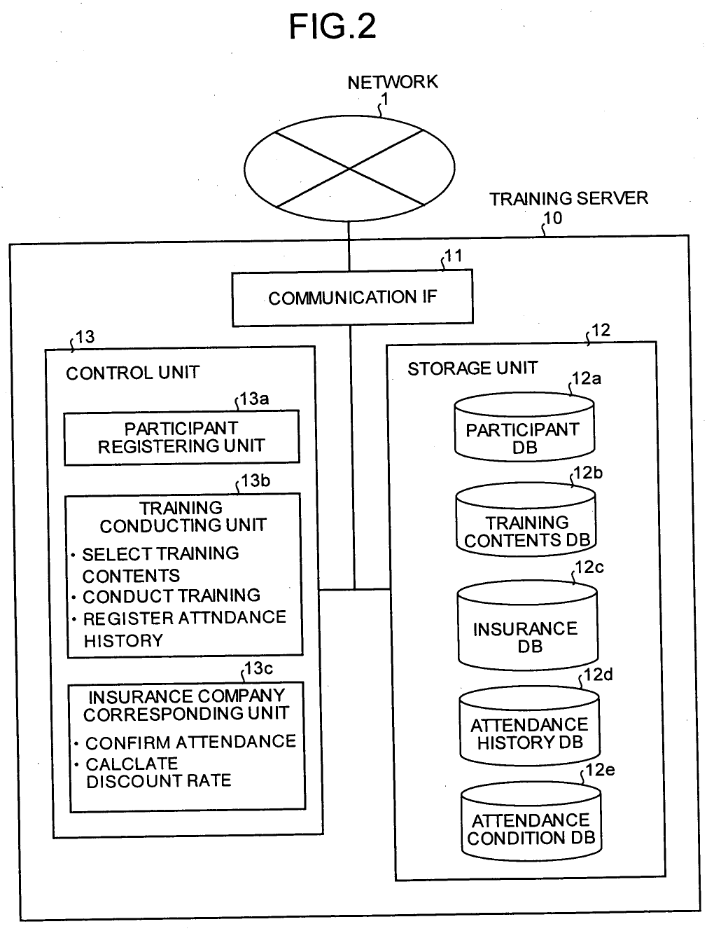

A structure of the training server 10 that is the core of the training system according to the embodiment of the present invention is explained next with reference to FIG. 2 through FIG. 7. FIG. 2 is a block diagram of the training server 10. The training server 10 includes a communication interface (IF) 11, a storage unit 12, and a control unit 13. The communication IF 11 controls the communication related to a data exchange between the consumer terminal device 20 and the training server 10 or the communication between the insurance company terminal device 30 and the training server 10 via the network 1. The storage unit 12 and the control unit 13 are explained next in detail.

The storage unit 12 stores data (for instance, Web data transmitted to the consumer terminal device 20) and programs required in various types of processes executed by the control unit 13. The storage unit 12 includes a participant database (DB) 12a, a training contents DB 12b, an insurance DB 12c, an attendance history DB 12d, and an attendance condition DB 12e.

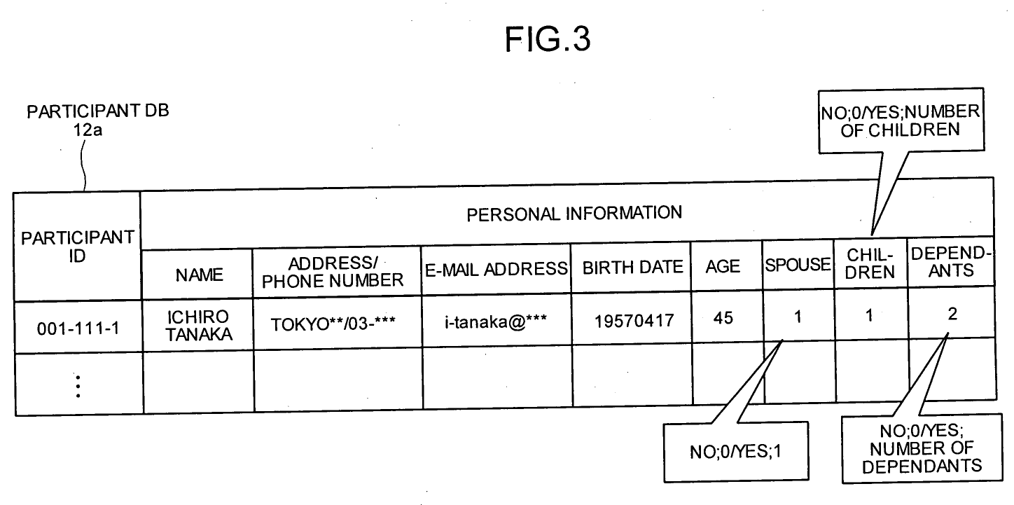

The participant DB 12a stores various types of personal information relating to the consumers who attend the training delivered by the training server 10. More specifically, as shown in FIG. 3, the participant DB 12a corresponds to a participant ID (number) of every participant and stores the personal information of every participant such as name, address/phone number, e-mail address, birth date, age, spouse, children, dependants, etc.

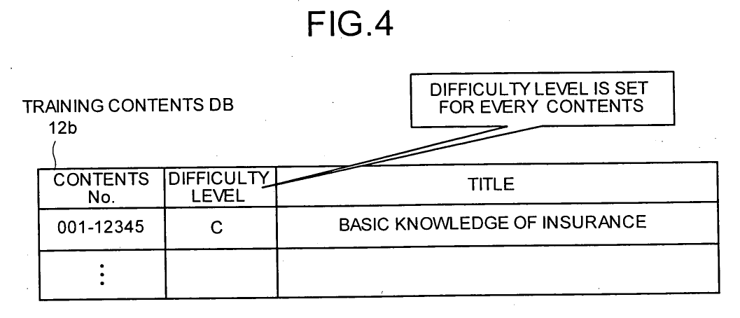

The training contents DB 12b stores various types of contents pertaining to the training conducted for the participants. More specifically, as shown in FIG. 4, the training contents DB 12b corresponds to contents No. of every session and stores difficulty level, entity data of contents, etc. The entity data of contents includes mail data and Web data transmitted to the consumer terminal device 20.

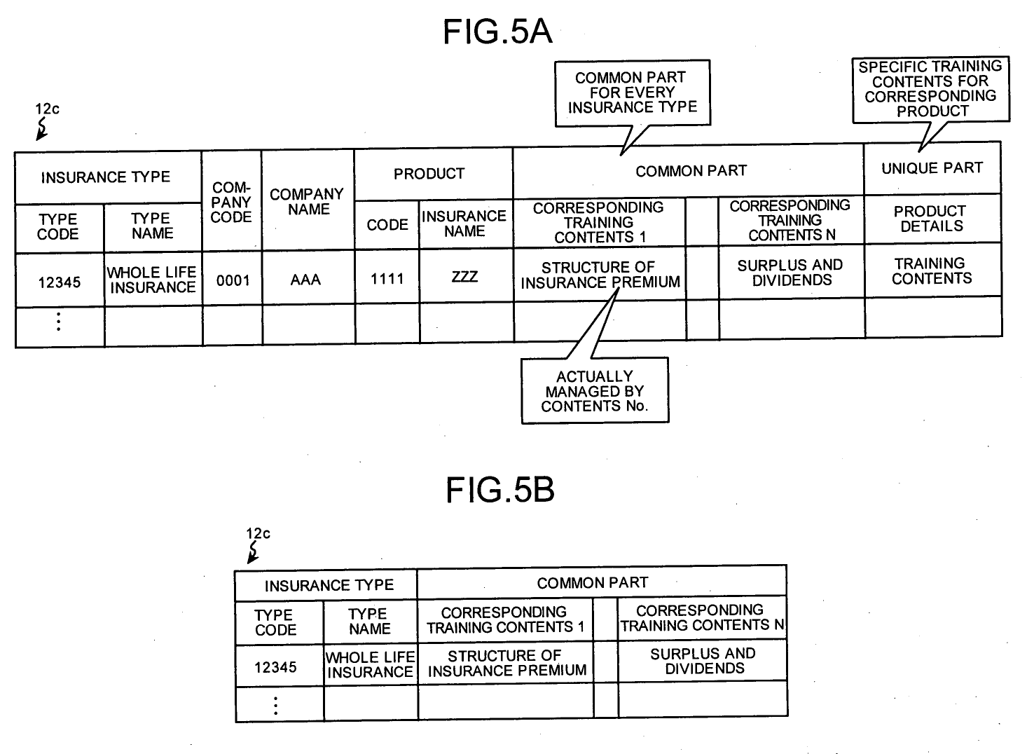

The insurance DB 12c stores the correspondence between the insurance types and the training contents offered by the insurance company. More specifically, as shown in FIGS. 5A and 5B, the insurance DB 12c includes a database that stores information pertaining to the participants who are going to specify the life insurance company (specific insurance products) and receive the training, and a database that stores information pertaining to the participants who are not going to specify the life insurance company and receive the training for the time being.

As shown in FIG. 5A, the former database (the database that stores information pertaining to the participants who specify the life insurance company) corresponds to each insurance type (a type code and a type name) and stores company code, company name, product (product code and product name), training contents common to every insurance type, and specific training contents for each product, etc. As shown in FIG. 5B, the later database (the database that stores information pertaining to the participants who do not specify the life insurance company) corresponds to each insurance type (the type code and the type name) and stores the training contents common to every insurance type.

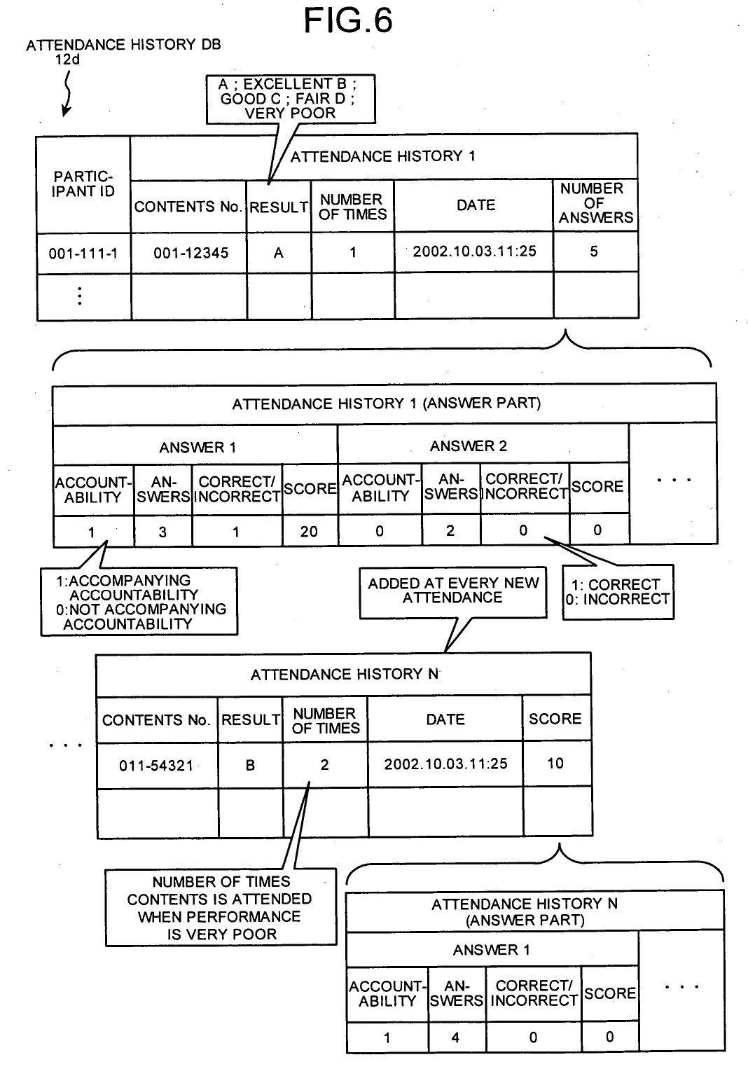

The attendance history DB 12d stores the progress of the training conducted for the participants as the history. More specifically, as shown in FIG. 6, the attendance history DB 12d corresponds to a participant ID (number) of each participant and stores the attended contents No., test result, number of times the training contents is attended by the participant, date when the training contents is attended by the participant, number of answers, etc. for every training contents attended by the participant. The breakdown of the answers of the participants is stored in the “number of answers” so as to know whether the participant has answered the questions corresponding to the accountability correctly.

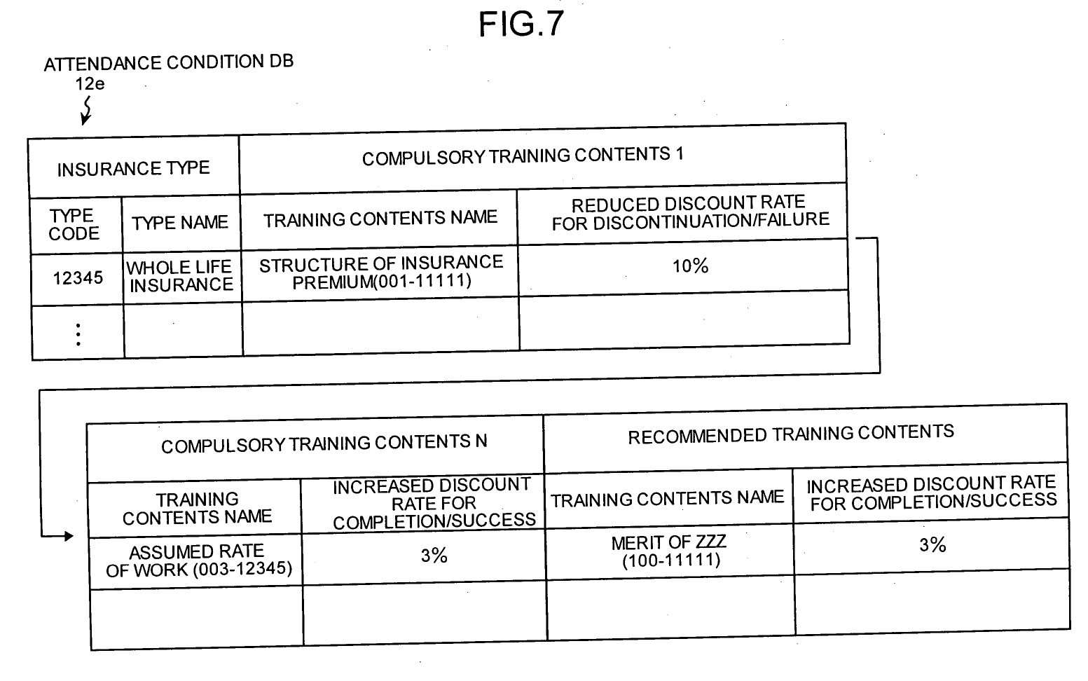

The attendance condition DB 12e stores the attendance conditions that are required for obtaining the discount on the insurance premium when signing the insurance sales contract. More specifically, as shown in FIG. 7, the attendance condition DB 12e corresponds to each insurance type (the type code and the type name) and stores a training contents name and a reduced discount rate for discontinuation/failure for every compulsory training contents, and a training contents name and an increased discount rate for completion/success for every recommended training contents.

Referring back to the control unit 13 of the training server 10 shown in FIG. 2, the control unit 13 has an internal memory that stores control programs such as an operating system (OS), a program (for instance, participant certification program, etc.) in which various types of procedures are specified, and the necessary data. The control unit 13 is a processor that executes different processes with the aid of the aforementioned programs and data. More specifically, the control unit 13 includes a participant registering unit 13a, a training conducting unit 13b, and an insurance company corresponding unit 13c.

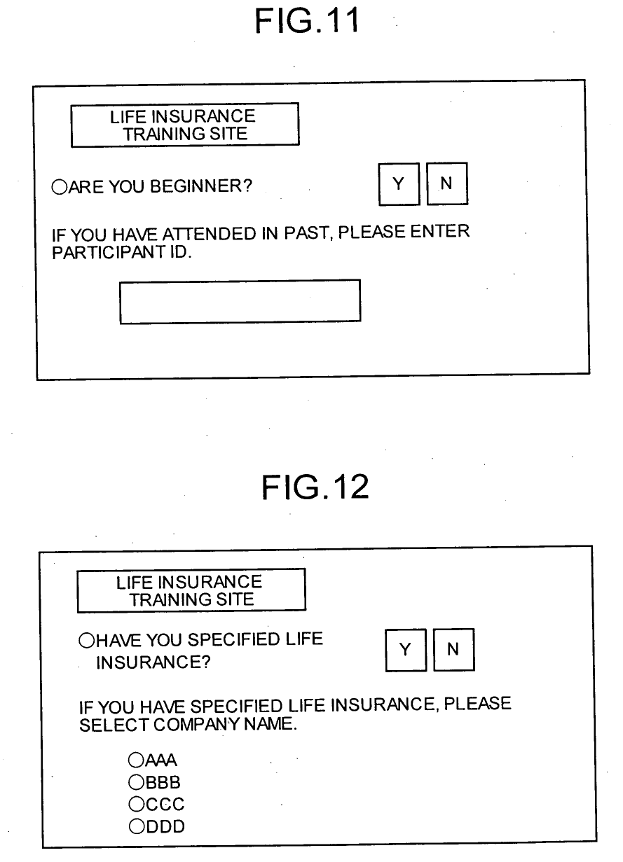

The participant registering unit 13a receives various types of personal information from the consumers (the participants) via the consumer terminal device 20 and registers the received personal information in the participant DB 12a. More specifically, a screen shown in FIG. 11 is displayed on the consumer terminal device 20, a consumer is made to enter various types of personal information, and the entered personal information is registered in the participant DB 12a.

The training conducting unit 13b executes various types of processes pertaining to the training such as selection of the training contents provided to the participants, conducting an e-Learning (e-mail transmission, Web data transmission, etc.) based training based on the selected training contents, registering in the attendance history DB 12d the progress of the training conducted for the participants, and the like. The features of the processes executed by the training conducting unit 13b are explained next.

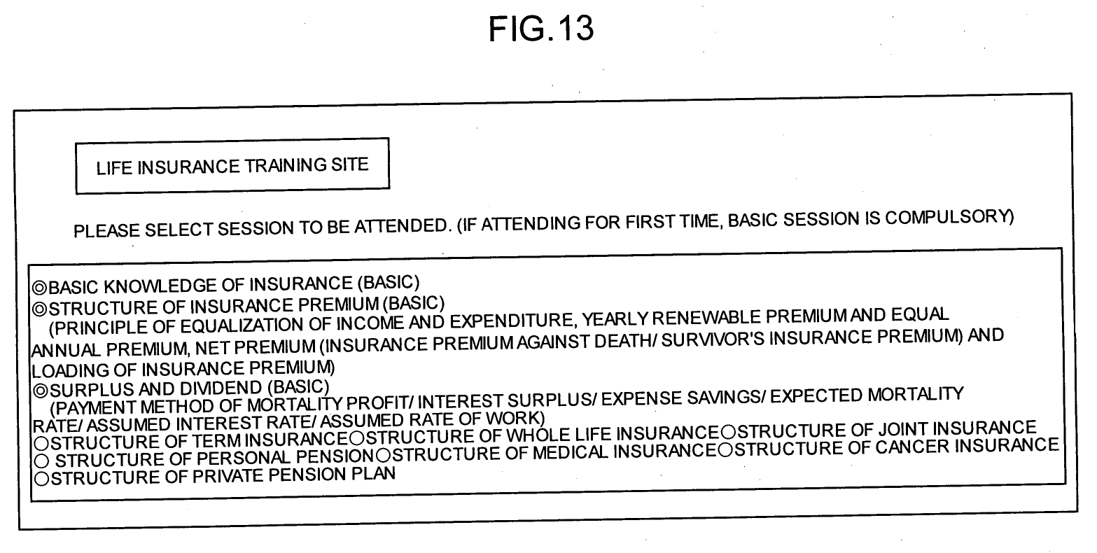

By means of the training conducting unit 13b, the training, according to the type of the insurance product selected by the participant, is conducted. More specifically, the insurance DB 12c shown in FIGS. 5A and 5B is referred, the screen shown in FIG. 12 and FIG. 13 is displayed on the consumer terminal device 20, the consumer is made to select the life insurance company (the insurance product) that he/she desires purchasing contract of, and the suitable training is conducted based on the selected product. More specifically, if the participant selects a specific product by specifying the life insurance company, based on the DB (the database that stores information pertaining to the participants who specify the life insurance company) shown in FIG. 5A, the training contents (contents No.) for conducting the training common to the insurance type that includes the product, and the training contents (contents No.) for conducting the product specific training for the selected product are selected.

Further, if a participant does not select the aforementioned training contents and does not specify the life insurance company, but selects a specific insurance type, based on the DB (the database that stores information pertaining to the participants who do not specify the life insurance company) shown in FIG. 5B, the training contents (contents No.) for conducting the training common to the insurance type is selected with the aid of the training conducting unit 13b. In other words, a basic training, which will serve as a data for making the decision, is conducted for the consumers who have no data for selecting the specific insurance product, and then the specific product is selected. Subsequently, the product specific training for the selected insurance product is conducted.

By means of the training conducting unit 13b, the training, according to the history of the training which is already executed for the participants and is stored in the attendance history DB 12d, is conducted. More specifically, with the aid of the training conducting unit 13b, the training contents repeated in the past attendance history are excluded, an intensive training is conducted for the areas in which the performance is poor according to the attendance history, the rate of progress of a training curriculum is adjusted according to the attendance history, and a suitable training is executed according to the attendance history.

Moreover, by means of the training conducting unit 13b, the participant DB 12a is referred and the training according to the attributes of each participant is conducted. More specifically, with the aid of the training conducting unit 13b, the selection of the insurance product according to the age of the participant is encouraged, an actual test that reflects the family structure of the participant is conducted, and based on the attributes such as the age, occupation, family structure, etc. of the participant, the suitable training is conducted.

By means of the training conducting unit 13b, the test for testing the result of the training is conducted for the participants and the results of the test are registered in the attendance history DB 12d as history. More specifically, the training is conducted by stimulating with the help of the test the willingness of the participants who receive the training, and by objectively revealing by means of the test result the degree of understanding of the participants.

Referring back to the control unit 13 shown in FIG. 2, the insurance company corresponding unit 13c performs various types of processes corresponding to the insurance company (in cooperation with the insurance company) such as responding to an attendance assessment from the insurance company terminal device 30, displaying the discount rate of the insurance premium on the insurance company terminal device 30, etc. The features of the processes performed by the insurance company corresponding unit 13c are explained below.

By means of the insurance company corresponding unit 13c, the attendance history DB 12d and the attendance condition DB 12e are referred according to the inquiry from the insurance company terminal device 30, and whether the contract applicant satisfies the attendance conditions is assessed. More specifically, in the insurance companies that have the insurance company terminal device 30, the attendance assessment is performed according to the inquiry from the insurance company terminal device 30 so that the sales contract of the insurance product can be conducted assuming that the participants have fully understood the contents of accountability through the training.

When the attendance history of the contract applicant satisfies the attendance conditions (when the participant clears the test, the explanation is given using the attendance history DB 12d shown in FIG. 6, and the participant answers all the questions pertaining to accountability correctly) at the time of attendance assessment, the discount on the insurance premium is calculated with the aid of the insurance company corresponding unit 13c. More specifically, in the insurance companies that have the insurance company terminal device 30, the discount on the insurance premium is calculated so that a profit known as the discount on the insurance premium can be offered and the insurance sales contract can be executed.

However, by means of the insurance company corresponding unit 13c, when the attendance history of the contract applicant does not satisfy the attendance conditions (when the participant fails to clear the test), the deficit of the training contents is provided to the insurance company terminal device 30, and an immediate confirmation pertaining to whether the contract applicant wishes to attend the deficit of the training contents is taken.

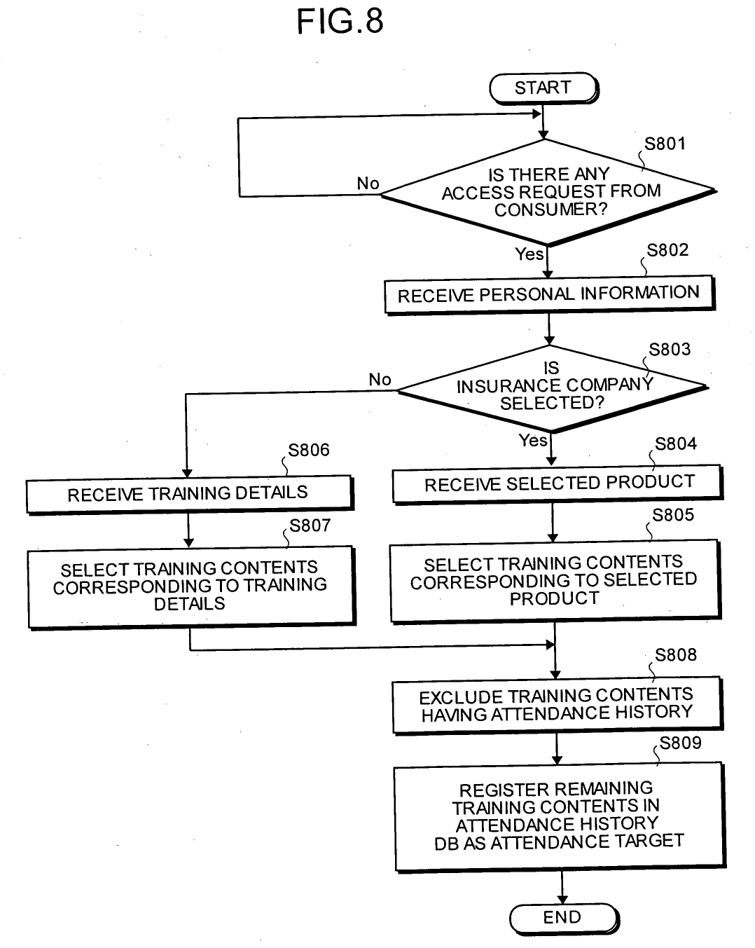

The procedure of the training server 10 is explained next with reference to FIG. 8 through FIG. 14. The processes performed by the training server 10 are classified and explained next as (1) training contents selection process, (2) training process, and (3) insurance company correspondence process.

(1) Training Contents Selection Process

FIG. 8 is a flowchart of the training contents selection process. When there is an access request from the consumer terminal device 20 of the consumer (the participant) (“Yes” at step S801), the training server 10 transmits the screen shown in FIG. 11 to the consumer terminal device 20, receives the personal information of the participant, and registers the received personal information in the participant DB 12a (step S802). If the consumer has attended the training before, the personal information is not received but as shown in FIG. 11, the input of attendance ID is received, and the process moves to step S803.

The training server 10 transmits the screen shown in FIG. 12 to the consumer terminal device 20, allows the consumer to select the life insurance company (the insurance product) he/she desires the purchasing contract of (step S803). When the participant specifically selects the life insurance company (“Yes” at step S803), the training server 10 further receives the selection of the specific product from amongst the products offered by the life insurance company (step S804). Then, according to the selection of the product, the DB shown in FIG. 5A is referred, the training contents (contents No.) for conducting the training common to the insurance type that includes the product, and the training contents (contents No.) for conducting the product specific training for the selected product are selected (step S805).

On the contrary, if the participant does not select the life insurance company (“No” at step S803), the training server 10 transmits the screen shown in FIG. 13 to the consumer terminal device 20, and receives the selection of the training details (the insurance type) to be attended (step S806). Then, according to the selection of the insurance type, the DB shown in FIG. 5B is referred, and the training contents (contents No.) for conducting the training common to the insurance type are selected (step S807).

Following the process of step S805 or step S807, the training server 10 refers to the attendance history DB 12d, and excludes the training contents repeated in the past attendance history from amongst the training contents selected at step S805 or step S807 (step S808). Then, the training server 10 registers the contents No. of the remaining training contents in the attendance history DB 12d as the attendance target (step S809).

(2) Training Process

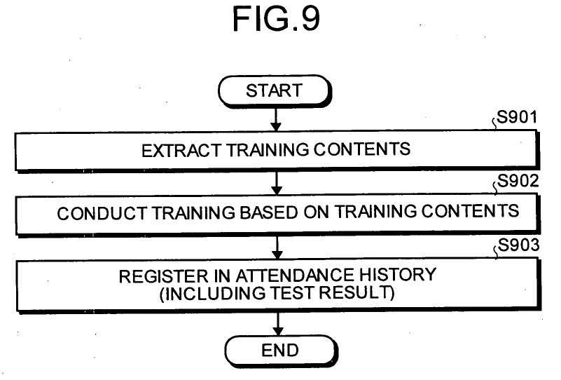

FIG. 9 is a flowchart of the training process. The training server 10, following the training contents selection process, refers to the attendance history DB 12d, and extracts from the training contents DB 12b the training contents registered as the attendance target (step S901).

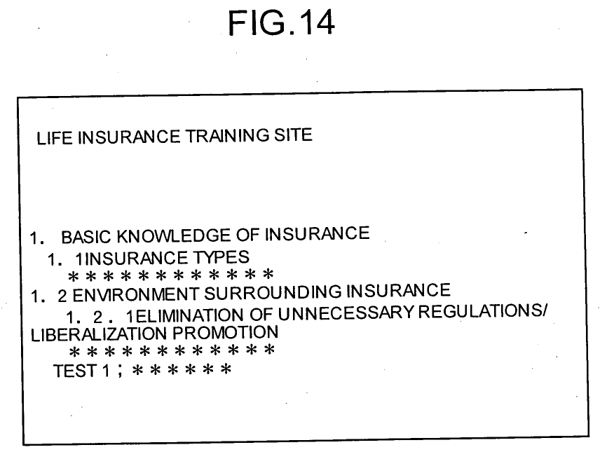

Then, the training server 10 transmits, based on the extracted training contents, the screen shown in FIG. 14 to the consumer terminal device 20, and conducts the e-Learning based training (step S901). The test for testing the result of the training of the participants is conducted in the training.

On conducting the training following the aforementioned processes, the training server 10 registers the progress of the training conducted for the participants as the history in the attendance history DB 12d, and also registers the test result in the attendance history DB 12d (step S903). By means of the training server 10, the participant ID is issued on completing the attendance of the session.

(3) Insurance Company correspondence Process

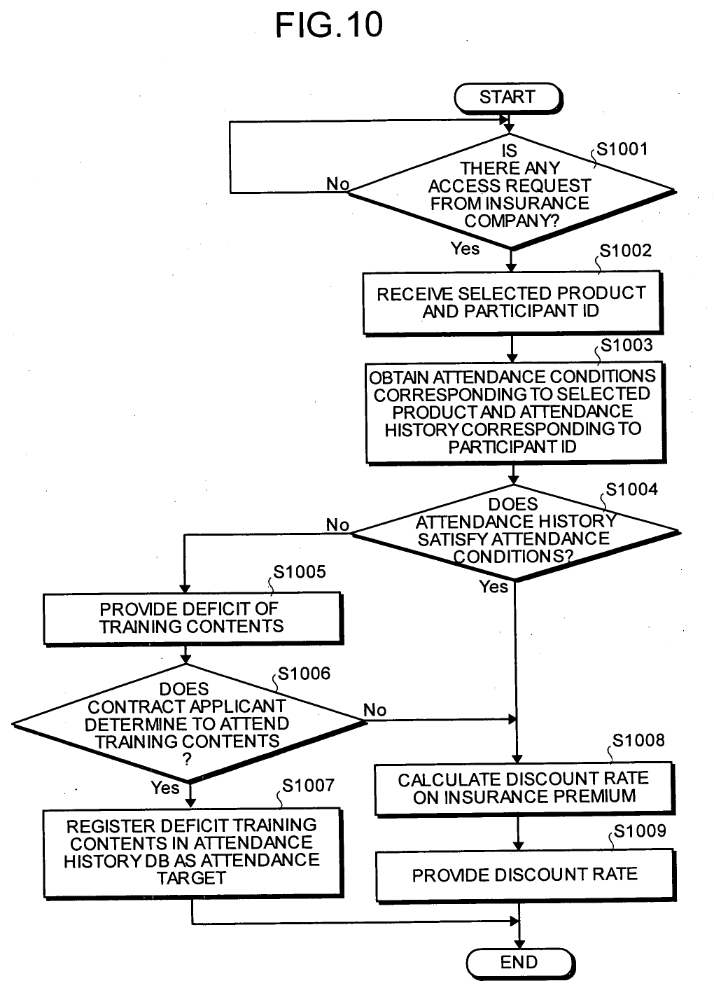

FIG. 10 is a flowchart of the insurance company correspondence process. When there is an access request from the insurance company terminal device 30 of the insurance company (“Yes” at step S1001), the training server 10 receives, from the insurance company terminal device 30, a selected product and the participant ID of the contract applicant (step S1002).

The training server 10 gets, from the attendance condition DB 12e, the attendance conditions corresponding to the selected product received from the insurance company terminal device 30, and simultaneously gets, from the attendance history DB 12d, the attendance history corresponding to the received participant ID (step S1003). Then, the training server 10 assesses whether the attendance history satisfies the attendance conditions (step S1004).

If the attendance history does not satisfy the attendance conditions (“No” at step S1004), the training server 10 provides, via the insurance company terminal device 30, the deficit of the training contents to the contract applicant and the salesperson (step S1005), and confirms whether the contract applicant wishes to attend the deficit of the training contents (step S1006).

Then, when the contract applicant determines to attend the training contents (“Yes” at step S1006), the training server 10 registers the contents No. of the deficit of the training contents in the attendance history DB 12d as a new attendance target (step S1007).

On the contrary, if the attendance history satisfies the attendance conditions (“Yes” at step S1004) or when the contract applicant does not determine to attend the training contents (“No” at step S1006), the training server 10 refers to the attendance condition DB 12e, and calculates the discount on the insurance premium (step S1008). Then, the training server 10 provides the calculated discount on the insurance premium to the insurance company terminal device 30 (step S1009).

A consumer's (participant Mr. X) perspective on the usage of the training system according to the embodiment of the present invention is explained next. Mr. X thinks of having an insurance policy at the time of employment. He hears from his school friend that there is a training attendance site on the life insurance from where he can study the “Basics” of the life insurance. Completing the training (though passing the test is a prerequisite, if one studies according to a Web curriculum, passing the test is not a difficult task) would reduce the monthly payment, and hence Mr. X decides to attend the session on “life insurance e-Learning”.

Mr. X accesses the training server 10 from his personal consumer terminal device 20 and opens the life insurance e-Learning site. On accessing the life insurance e-Learning site, the screen shown in FIG. 11 is displayed. Mr. X is asked whether he is a beginner, and hence he selects “Beginner”. On selecting “Beginner”, the screen shown in FIG. 12 is displayed. Although Mr. X is asked in the beginning whether the life insurance company is specified, he selects “Not specified” since the life insurance company is not yet decided. Following the selection of “Not specified”, the screen shown in FIG. 13 is displayed. Though session is selected, Mr. X selects the “Whole life insurance” since he desires to have the whole life insurance. When selecting the session, the beginner needs to select the basic session, and hence basic session is selected by default.

Then, the screen shown in FIG. 14 is displayed and the life insurance session starts. Mr. X receives the training according to the curriculum (screen progress). The first session is completed on finishing the test. Correct/incorrect answers and the pass/fail result of the test are displayed on clicking the test confirmation button on the screen. Because the result of the test is 60 points (70 or more points indicate passing), Mr. X goes back to the incorrect answers (where the incorrect answers are displayed), studies again, and attempts the test again. The result comes out to be 85 points. Thus, Mr. X attends all the sessions to be attempted this time (he clears all the tests and finally the participant ID is issued).

Later, because an acquaintance of Mr. X is working for AAA insurance company, Mr. X thinks that he should join the whole life insurance of AAA insurance company. He goes to the salesperson of AAA insurance company, and offers the subscription of the whole life insurance. Mr. X produces the participant ID because he is asked by the salesperson whether a session on e-Learning of the life insurance is taken. Then, the salesperson accesses the training server 10 from the insurance company terminal device 30, enters Mr. X's participant ID and the desired insurance product, and confirms whether the attendance history satisfies the attendance conditions.

On receiving the confirmation, Mr. X is communicated that he is liable for a regular discount because all the compulsory sessions were attended (cleared) by him. However, because Mr. X has not attended a session on “ZZZ” which is the whole life insurance of AAA insurance company, he is asked whether to sign the contract after attending the session, or, whether to sign the contract with regular discount but without any further rise in the discount rate. Mr. X inquires whether the session on “ZZZ” can be attended in the present situation, the salesperson answers that a terminal for the visitors is provided and hence it would be possible to attend the session in the present situation.

Because Mr. X immediately decides to attend the session on “ZZZ”, he accesses the training server 10, and opens the life insurance e-Learning site. The screen shown in FIG. 11 is displayed. Because Mr. X accesses the site for the second time, he enters the participant ID. This time since Mr. X has attended the session pertaining to the products of AAA insurance company, on selecting “AAA”, a product selection screen of AAA insurance company is displayed, and Mr. X selects the desired “ZZZ” product.

Because Mr. X previously attended all the sessions on the whole life insurance, the contents of the session to be attended this time included specific products such as “ZZZ”. Mr. X has studied in the previous training, the insurance in general and the whole life insurance. As a result, he could understand the contents of the session easily. Mr. X carefully studies only the insurance policy difference of various insurance companies pertaining to the present product, and scores 95 points in first attempt in the final test.

Thus, at the end of the training, Mr. X notifies the salesperson of the completion of attendance. The training server 10 is accessed from the insurance company terminal device 30, and whether the attendance history satisfies the attendance conditions is confirmed. Consequently, it is revealed that all the sessions are completed and an additional 3% discount rate will be applied to the regular discount rate (tentatively 10%) totaling it to 13% of the discount.

Mr. X receives an estimation of “ZZZ” from the salesperson. The estimation is a standard monthly payment of “20,000 yen”. However, when the discount rate due to attendance is applied, it is estimated as “20,000*(1−0.13)=“17,400 yen”. Then, Mr. X immediately decides to sign the contract of “ZZZ”.

Thus, attending the training on life insurance e-Learning enabled Mr. X to receive the discount at the time of the contract. AAA insurance company enabled Mr. X to avoid the trouble when making the payment, because Mr. X had good knowledge of the product and the terms and conditions when signing the contract of (Because the contract is executed after taking the consent) the product (life insurance) (even when a lawsuit is filed, a proof can be submitted that the policyholder has understood the product with the aid of the attendance history). Further, AAA insurance company can reduce the training expenses to the salesperson, thereby reducing the cost and the insurance premium of the product. Furthermore, the share can be expanded as a result of an improvement in customer satisfaction and differentiation with the other companies.

Another embodiment is explained next by classifying into (1) product target, (2) profit of the consumer, (3) system configuration, and (4) program.

(1) Product Target

Though a usage of the insurance product in the training system is explained in the present embodiment, the present invention is not limited to the present embodiment. However, for instance, the present invention can also be similarly applied for the products (including services) such as other financial products, house renting etc. that require consumer accountability when selling or renting the products.

(2) Profit of the Consumers

Though executing a contract sale that offers the discount on the insurance premium according to the result of the test is explained in the present embodiment, the present invention is not limited to the present embodiment. The present invention can be applied in a way so that only a person who has cleared the test (only those participants who answer correctly all the questions pertaining to accountability as shown in FIG. 6) is allowed to execute the contract. In other words, the occurrence of trouble can be eliminated beforehand by making a predetermined test result a prerequisite for accountability.

Moreover, providing a difference in the discount rate depending on whether the participant passes the test is explained in the present embodiment, the present invention is not limited to the present embodiment. The present invention can also be applied in a way so that the increase in the discount rate is based on the test score of the successful participants. In other words, the understanding of the consumer can be further improved effectively by further stimulating the willingness of the consumer for the training.

Though the offer of a discount on the insurance premium as a profit to the consumers (the participants) is explained in the present embodiment, the present invention is not limited to the present embodiment. The present invention can be similarly applied to coupons that can be used when purchasing the products or points addition to the so-called mileage cards, providing points which have a predetermined counter value, etc.

(3) System configuration, etc

Though a system in which the training server 10 and the insurance company terminal device 30 are provided separately on the network 1 is explained in the present embodiment, the present invention is not limited to the present embodiment. However, the system that combines both the training server 10 and the insurance company terminal device 30 into one device may be devised. Providing the training server 10 and the insurance company terminal device 30 separately enables exclusive handling of the insurance product of a plurality of life insurance companies and conducting an efficient training, Providing the training server 10 and the insurance company terminal device 30 separately also enables to preserve the public utility and the neutrality of the training server 10 as a training institution.

The constituent elements of the device illustrated are merely conceptual and may not necessarily physically resemble the structures shown in the drawings. For instance, the device need not necessarily have the structure that is illustrated. The device as a whole or in parts can be broken down or integrated either functionally or physically in accordance with the load or how the device is to be used. The process functions of the apparatus can be wholly or partially realized by the CPU or a program run by the CPU or can be realized by hardware through wired logic.

All the automatic processes explained in the present embodiment can be, entirely or in part, carried out manually. Similarly, all the manual processes explained in the present embodiment can be entirely or in part carried out automatically by a known method. The procedure of processes, the sequence of controls, specific names, and data including various parameters can be changed as required unless otherwise specified.

(4) Program

Various types of processes explained in the present embodiment can be realized by executing an already provided program with the aid of a computer system such as a personal computer or a workstation. The computer system that executes the program having functions similar to the present embodiment is explained next.

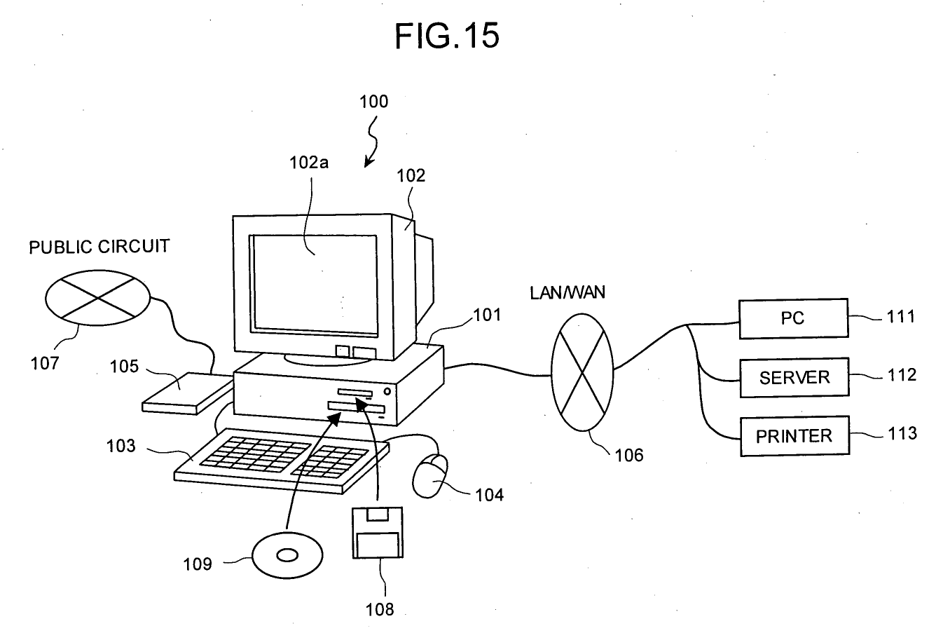

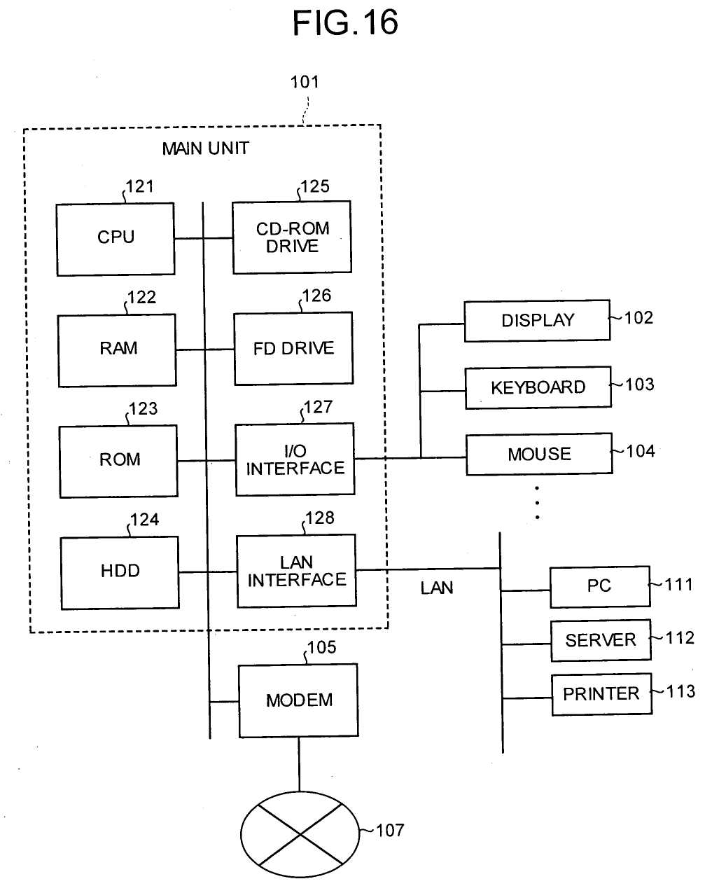

FIG. 15 is a drawing illustrating the computer system. FIG. 16 is a block diagram of a main unit of the computer system. As shown in FIG. 15, a computer system 100 includes a main unit 101, a display 102 that displays the information such as images, etc on a display screen 102a as per the instructions from the main unit 101, a keyboard 103 that enters various information in the computer system 100, and a mouse 104 that specifies arbitrary positions on the display screen 102a of the display 102.

As shown in FIG. 16, the main unit 101 in the computer system 100 includes a central processing unit (CPU) 121, a random access memory (RAM) 122, a read only memory (ROM) 123, a hard disk drive (HDD) 124, a compact disk-read only memory drive (CD-ROM drive) 125 that accepts a compact disk-read only memory (CD-ROM) 109, a floppy disk drive (FD drive) 126 that accepts a flexible disk (FD) 108, an input and output interface (I/O interface) 127 that connects the display 102, the keyboard 103, and the mouse, and a local area network interface (LAN interface) 128 that is connected to a local area network or a wide area network (LAN/WAN) 106.

Further, the computer system 100 is connected to a modem 105 that connects to a public circuit 107 such as the Internet, etc. The computer system 100 is connected to other computer system (PC) 111, a server 112, and a printer 113 via the LAN interface 128 and the LAN/WAN 106.

The computer system 100 realizes the functions similar to the aforementioned embodiment by reading and executing the program stored on a predetermined recording medium. The predetermined recording medium includes all the recording media that record the program read by the computer system 100. The predetermined recording medium may be the flexible disk (FD) 108, the compact disk-read only memory (CD-ROM) 109, a magneto optical disk (MO disk), and a digital versatile disk (DVD disk). Apart from a “portable physical medium” such as the magneto optical disk, integrated circuit card (IC card), etc, the predetermined recording medium may be a “fixed physical medium” such as the hard disk drive (HDD) 124, the RAM 122, the ROM 123, or further, the public circuit 107 that is connected to the computer system 100 via the modem 105 or the LAN/WAN 106 that is connected to other computer system 111 and the server 112.

In other words, the program in the other embodiment is a computer readable program stored on the aforementioned recording medium such as the “portable physical medium”, “fixed physical medium”, “communication medium”, etc. The computer system 100 realizes the functions similar to the aforementioned embodiment by reading and executing the program from the aforementioned recording mediums. The program executed by the computer system 100 is explained in the other embodiment. However, the present invention can be similarly applied in a way so that the program can also be executed by the computer system 111 or by the server 112 or by a combination of the computer system 111 and the server 112.

According to the present invention, occurrence of trouble between a consumer and a seller can be avoided by facilitating the consumer to understand contents explained as a part of accountability pertaining to products that demand consumer accountability when selling.

The consent of a contract or a sale can be obtained on the assumption (for instance, as a guarantee of accountability for having received a training) that the consumer fully understands contents and terms and conditions of the product. Consequently, a policyholder is convinced about the insurance payment without any trouble, thereby enhancing the relationship between the insurance company and a policyholder (the consumer).

Financial products that represent the products having consumer accountability when selling, have a property in which new products are sold one after another due to the effect of social conditions or product development by other companies. Training salespersons requires tremendous amount of money, disadvantageous profits such as increase in cost, and the accompanying rise in selling price, given to both the insurance company and the policyholder due to insufficient imparting of explanation of the product and the terms and conditions of the contract costs heavily. However, the present invention helps eliminate the disadvantageous profits considerably.

Furthermore, according to the present invention, a suitable training is given based on the type of an insurance product that the consumer wishes to have purchasing contract of, thereby facilitating understanding of the consumer according to the type of the insurance product.

Moreover, according to the present invention, a basic training that will help the consumer to understand which insurance product is suitable for him/her is given and then a more specific training that specializes in the types of the insurance products that the consumer wishes to have the purchasing contract of is given, thereby improving the understanding of the consumer step-by-step.

Moreover, according to the present invention, the suitable training is conducted based on attributes such as age, occupation, family structure, etc of the consumer, thereby enhancing the understanding of the consumer.

Moreover, according to the present invention, training subjects repeated in the past attendance history are excluded, a training subject prescribed according to the attendance history is included in the training, and the suitable training according to the attendance history is given, thereby ensuring continuous improvement of understanding of the consumer.

Moreover, according to the present invention, a test stimulates willingness of the consumer who receives the training, and objectively reveals the degree of understanding of the consumer, thereby enhancing and consolidating the understanding of the consumer effectively.

Moreover, according to the present invention, the consumer fully understands the contents of accountability through the training, thereby ensuring a smooth execution of a sales contract of the financial product.

Moreover, according to the present invention, the occurrence of trouble can be eliminated beforehand by making a predetermined test result a prerequisite for accountability.

Moreover, according to the present invention, by offering a discount when merchandising in the form of incentives, the willingness of the consumers for the training is stimulated, thereby further enhancing the understanding of the consumers.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An apparatus for providing information on a product, which accompanies an accountability to a consumer at a time of selling the product, to a client device of the consumer via a network, the apparatus comprising:
a training conducting unit that conducts a training pertaining to the information for the consumer through the client device; and
a training-history storing unit that stores a training history indicating a progress of the training.

2. The apparatus according to claim 1, wherein the training conducting unit conducts the training based on a type of a product selected by the consumer.

3. The apparatus according to claim 2, wherein the training conducting unit conducts a training common to various types of products, and then a specific training for the type of the product selected by the consumer.

4. The apparatus according to claim 1, wherein the training conducting unit conducts the training based on personal information of the consumer.

5. The apparatus according to claim 1, wherein the training conducting unit conducts the training based on the training history stored.

6. The apparatus according to claim 1, wherein
the training conducting unit further conducts a test on the training conducted for the consumer, and
the training-history storing unit stores a result of the test as the training history.

7. The apparatus according to claim 1, further comprising a sales determining unit that determines whether the customer completed the training, based on the training history, and sells the product to the consumer who completed the training.

8. The apparatus according to claim 7, wherein the sales determining unit determines whether the customer passed the test with a predetermined level, based on the result of the test.

9. The apparatus according to claim 7, wherein the sales determining unit further determines a benefit to the customer, based on the result of the test.

10. A method for providing information on a product, which accompanies an accountability to a consumer at a time of selling the product, to a client device of the consumer via a network, the method comprising:
conducting a training pertaining to the information for the consumer through the client device; and
storing a training history indicating a progress of the training.

11. A computer-readable recording medium that stores a computer program for providing information on a product, which accompanies an accountability to a consumer at a time of selling the product, to a client device of the consumer via a network, wherein the computer program causes a computer to execute:
conducting a training pertaining to the information for the consumer through the client device; and
storing a training history indicating a progress of the training.
